(19) United States
(12) Patent Application Publication
(10) Pub. No.: US 2002/0101405 A1
(43) Pub. Date: Aug. 1, 2002

(54) Foldable input device

(76) Inventor: Cheng-Chung Chang, Taipei Shien (TW)

Correspondence Address: BACON & THOMAS, FOURTH FLOOR, 625 SLATERS LANE, ALEXANDRIA, VA, 22314, US

(21) Appl. No.: 09/769,350

(22) Filed: Jan. 26, 2001

(51) Int. Cl. G09G 5/00

(52) U.S. Cl. 345/168

(57) ABSTRACT

A foldable input device comprises two housings; a pivotal body being pivotally connected between the two housings; the two housings being foldable in half or expanded with respect to the pivotal body; an upper and a lower end of one of the housings being installed with a sliding track so that a key portion moves with respect to the housings; a sector plate is pivotally installed between one housing and the pivotal body so that the sector plate is connected to the pivotal body with one end thereof being used as a rotary shaft, while another end is inserted into the housing; the housing being capable of expanding with an angle with respect to the pivotal body; two key portions being embedded into surfaces of two housings and being positioned so that the left and right sides thereof being adjustable so as to provide a preferred operation condition to the user.

### FIELD OF THE INVENTION

The present invention relates to a foldable input device, and especially to an input device which can be used with a personal digital assistant and the operation is convenient, moreover, it can be carried out easily.

### BACKGROUND OF THE INVENTION

Since the personal digital assistants have compact volumes and versatile in functions so that it becomes more and more popular and thus, there is a trend that the personal digital assistant will become a necessity in near future by all peoples.

Since the personal digital assistant must be designed compact so that some applications are neglected, and thus, some built-in operation must be learnt by users. One of these operation is to input data. Since a standard keyboard is too large to be carried out with the personal digital assistant, and thus a pen operation is used. However, most people are habitual to use keyboards. Although some hand-writing input ways are developed, these methods are not popular and are inconvenient as mass-data are required to be inputted.

Some keyboards matching to the operations of personal digital assistants are invented and commercial sold, these keyboards are announced that they cab be carried conveniently. For example, a four-folded keyboard is developed and has a volume identical to that of a personal digital assistant. However, these products are not practical, since the volume is too smaller, thus the key is reduced and thus not ergonomic. It is easy to hurt the user hands as being used for a long time period. Furthermore, it is inserted into the personal digital assistant from a lateral side of the personal digital assistant so that the user must be tilt to view the screen of the personal digital assistant. Furthermore, the stability in inserting the keyboard is unstable so that it is very possible that the personal digital assistant will drop down. Another, the price is high and it is hard in expanding other functions.

Some foldable keyboards are developed, for example, U.S. Pat. Nos. 5,457,453, 5,653,543, etc. However, some novelties are provided, but no one can adjust the position thereof to match the habit and requirements of the user. These keyboards are separated with the personal digital assistant so that it is very often that the user forgets to carry it out.

### SUMMARY OF THE INVENTION

Accordingly, the primary object of the present invention is to provide a foldable input device, wherein it has a size of a general keyboard, and the distance and angle of the key is adjustable for matching the requirement of ergonomics so that it is suitable for a user to use it for a long time.

Another object of the present invention is to provide a foldable input device, wherein a personal digital assistant can be placed in a center place so that the user may view it convenient for avoiding an improper position to effect the health of the user.

A further object of the present invention is to provide a foldable input device, wherein the present invention can be incorporated with a personal digital assistant for saving space. More importantly, the user can not forgot to carry the input device as the user carry away the personal digital assistant.

A further object of the present invention is to provide a foldable input device, wherein other extra equipment can be added so as to enhance the function of a personal digital assistant and thus the present invention can be widely used in different applications. Therefore, the user may operate it conveniently.

The various objects and advantages of the present invention will be more readily understood from the following detailed description when read in conjunction with the appended drawing.

### BRIEF DESCRIPTION OF THE DRAWINGS

FIG. 1 is a front expanded perspective view of the present invention.

FIG. 2 is a rear expanded perspective view of the present invention.

FIG. 3 is a plane expanded view of the present invention.

FIG. 4 is a perspective view showing that the present invention is folded at one surface.

FIG. 5 is a perspective view showing that the present invention is folded at another surface.

FIG. 6 is a plane view showing a movement of the key portion in the present invention.

FIG. 7 is a plane view showing expansion of the present invention.

### DETAILED DESCRIPTION OF THE PREFERRED EMBODIMENTS

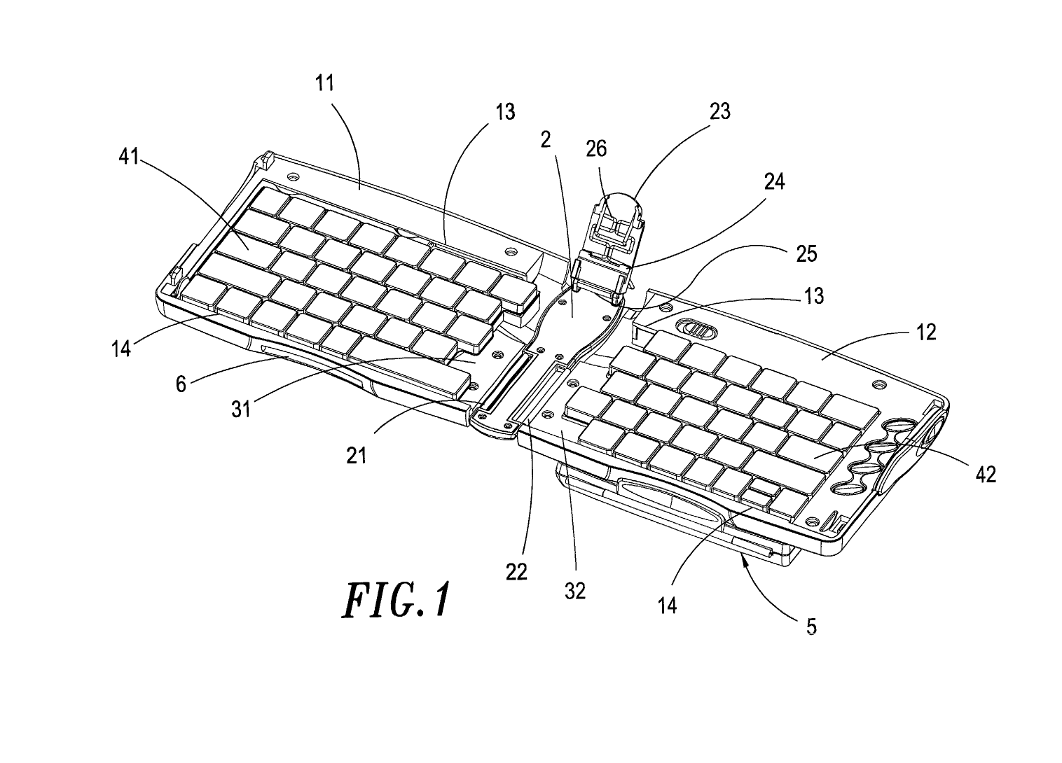

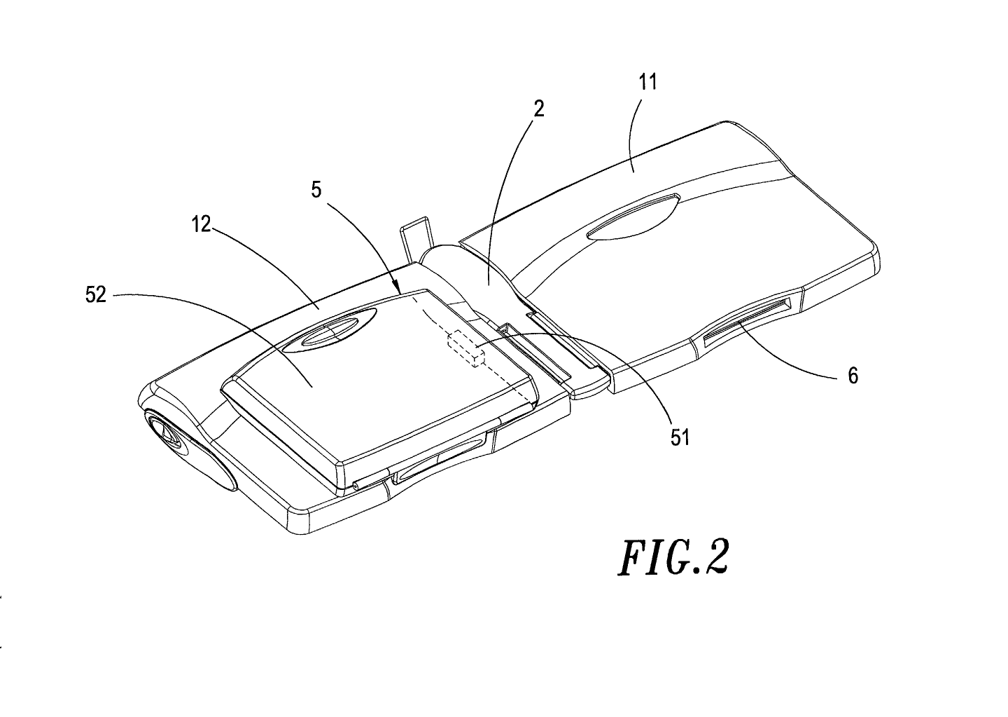

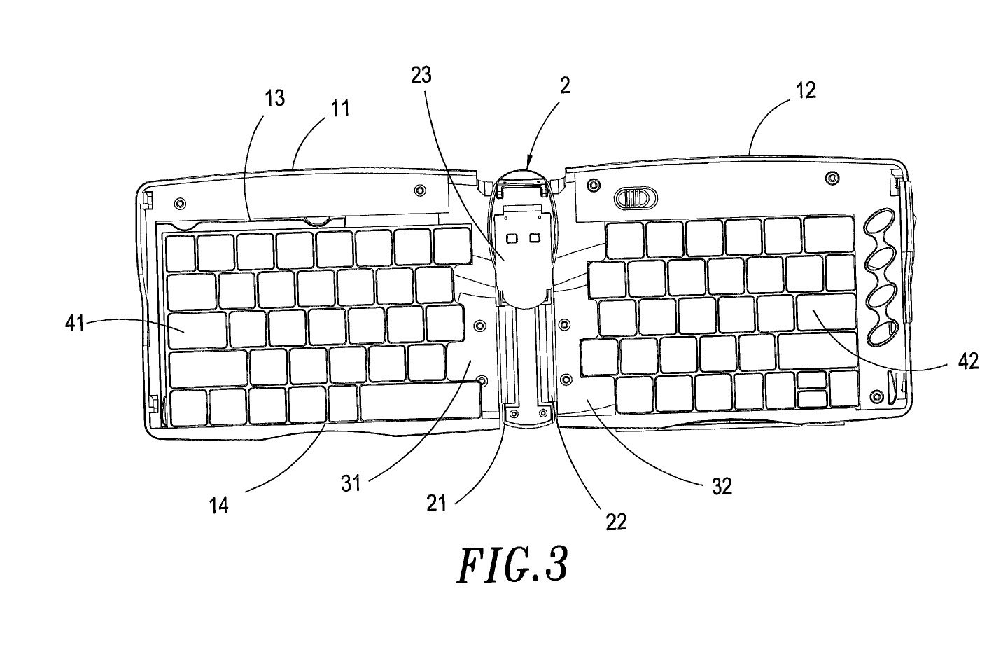

With reference to FIGS. 1 to 3, the foldable input device of the present invention is illustrated. The foldable input device of the present invention mainly includes two housings 11, 12; wherein a pivotal body 2 is pivotally connected between the two housings 11, 12; two ends of the pivotal body 2 has two ends which are connected to two sector plates 31, 32, respectively, through rotary shafts 21, 22. Another end of each of sector plates 31, 32 is inserted into a respective housings 11, 12 so that the two housings 11, 12 may be folded in half with respect to the pivotal body 2 or may swing. The surfaces of the two housings 11, 12 are embedded with two key portions 41, 42. The upper and lower ends of the housings 11, 12 are installed with sliding tracks 13, 14 with respect to the key portions 41, 42 so that the two key portions 41, 42 may move with respect to the housings 11, 12. A front end of the pivotal body 2 is installed with a receiving frame 23 for being installed by a personal digital assistant (not shown). A groove 24 is installed therein for being connected with the terminals of a personal digital assistant. The receiving frame 23 and the pivotal body 2 are connected to a rotary shaft 25 so that the receiving frame 23 is foldable and thus flatly adhered to the pivotal body 2. The surface of the receiving frame 23 is formed with an extending frame 231. In using, the extending frame 231 is expanded so as to be formed with a larger area for enhancing the stability of the personal digital assistant therein. The housings 11, 12 are further installed with a receiving space 5 for receiving a personal digital assistant or a battery. A groove 51 is installed in the receiving space 5 for being connected to the personal digital assistant or the terminals of the battery. A cover 52 serves to seal the receiving space 5. The housings 11, 12 are installed with extending slot 6. Thereby, other extra memory, network card, modem, or other PCMCIA cards can be installed therein for enhancing the function of the personal digital assistant.

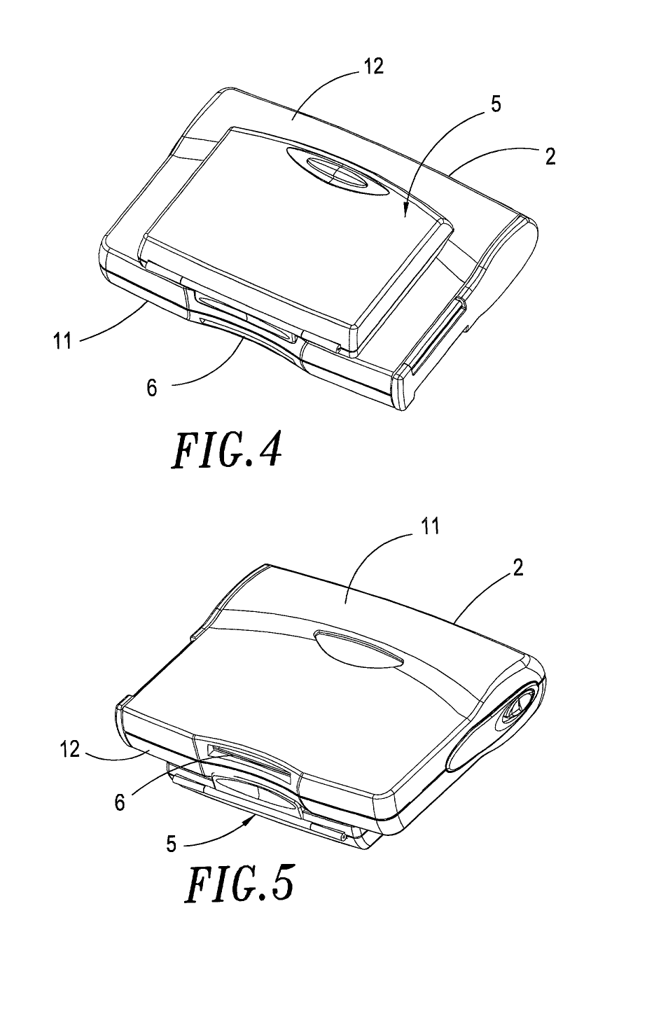

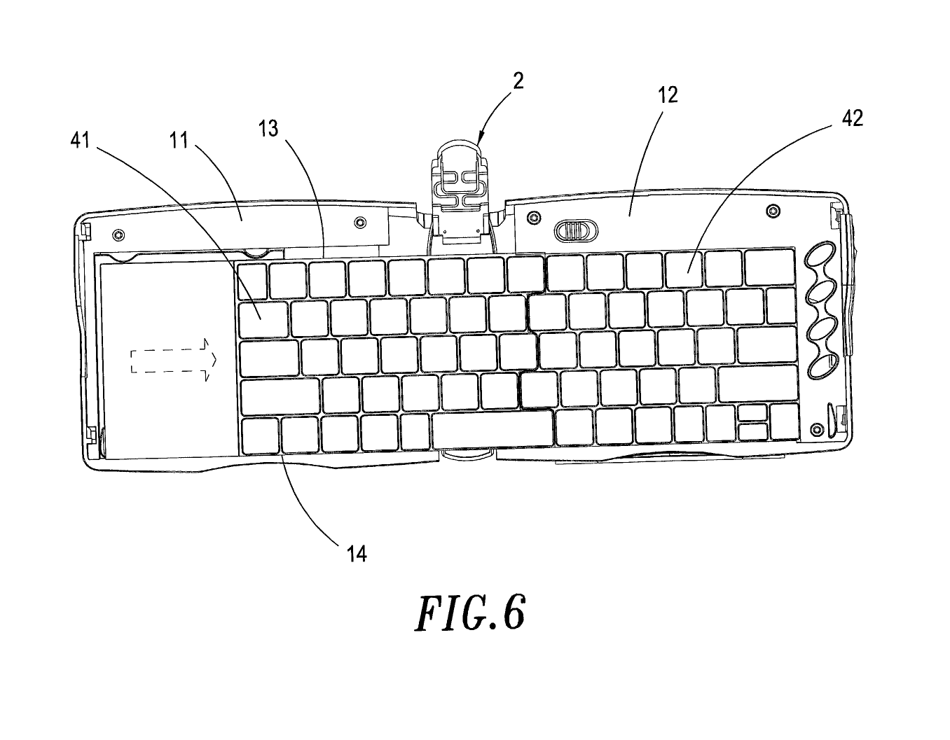

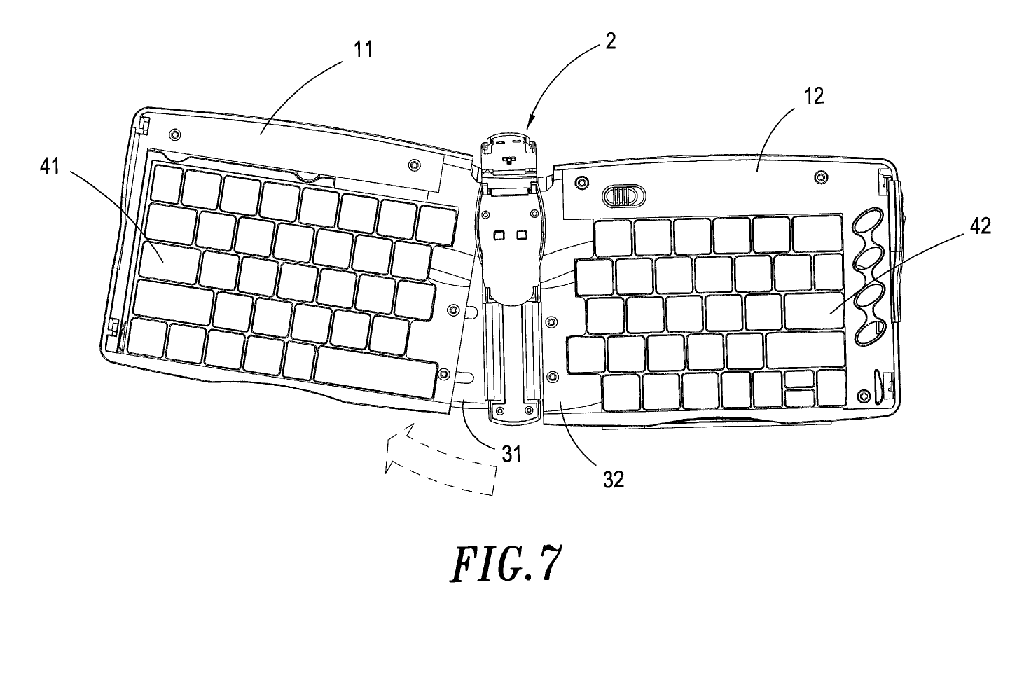

Referring to FIGS. 4 and 5, the housings 11, 12 may be folded in half along the pivotal body 2 so that the user may carry it convenient. A personal digital assistant can be placed in the receiving space 5 for saving the storing space and preventing not to be carried. The personal digital assistant can be charged by an external power source through the groove 51. When the two housings 11, 12 are expanded, the user may adjust the distance or orientation of the two key portions 41, 42 for being operated conveniently. Moreover, the user may expand the function of the personal digital assistant through the extending slot 6, such as the capacitance of the extending memory, or is directly connected to Internet so as to extend the ability infinitely. The circuits of aforesaid devices are received in the housings 11, 12, and are can be performed easily. Therefore, the details will not be further described herein. Referring to FIGS. 6 and 7, the two key portions 41, 42 are installed at the left half and right half of a standard keyboard. When the two housings 11, 12 are expanded, the key portion 41 at the left side may approach to the key portion 42 at the right side along the sliding tracks 13, 14 so as to be formed as a standard keyboard mode. Of course, it can be expanded to a proper length as desired. The key portion 41 may be expanded along the confinement of the sector plate 31 around an axis of the pivotal body 2 so as to match the requirement of a user. The aforesaid function of adjusting the length or expanding with an angle may be installed at a left half, a right half or both of the two sides of the folded input device.

Besides, in the present invention, a power source of a built-in battery or a personal digital assistant can be used. Of course, other external power source, such as a battery box or an AC power source, can also be used for reducing the power consumption of the personal digital assistant, and moreover, it can be charged.

The foldable input device of the present invention has the following advantages as comparing with the prior art designs:

1. As the present invention is expanded, it has a size of a general keyboard, and the distance and angle of the key is adjustable for matching the requirement of ergonomics so that it is suitable for a user to use it for a long time.

2. In the present invention, a personal digital assistant can be placed in a center place so that the user may view it convenient for avoiding an improper position to effect the health of the user.

3. The present invention can be incorporated with a personal digital assistant for saving space. More importantly, the user can not forgot to carry the input device as the user carry away the personal digital assistant.

4. Other extra equipment can be added so as to enhance the function of a personal digital assistant and thus the present invention can be widely used in different applications. Therefore, the user may operate it conveniently.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A foldable input device comprising:
two housings; a pivotal body being pivotally connected between the two housings; the two housings being foldable in half or expanded with respect to the pivotal body; an upper and a lower end of one of the housings being installed with a sliding track so that a key portion moves with respect to the housings; a sector plate being pivotally installed between one housing and the pivotal body so that the sector plate is connected to the pivotal body with one end thereof being used as a rotary shaft, while another end is inserted into the housing; each housing being capable of expanding with an angle with respect to the pivotal body;
two key portions being embedded into surfaces of two housings and being positioned so that the left and right sides thereof being adjustable so as to provide a preferred operation condition to the user.

2. The foldable input device as claimed in claim 1, wherein the sliding track is installed in the left housing or right housing, or both of the two housings.

3. The foldable input device as claimed in claim 1, wherein the sector plate is installed between the pivotal body and the left housing, or between the pivotal body and the right housing, or between the pivotal body, the left housing, and the right housing.

4. The foldable input device as claimed in claim 1, wherein a receiving frame is installed in front of the pivotal body; the receiving frame has a groove for being inserted by a terminal portion of a personal digital assistant; a surface of the receiving frame has an extending frame which is capable expanded for increasing area; and the receiving frame and the pivotal body are connected to a rotary shaft so that the receiving frame is foldable and thus flatly adhered to the pivotal body.

5. The foldable input device as claimed in claim 1, wherein any housing is installed with a receiving space which serves to locate a personal digital assistant or a standby battery; the receiving space is formed with a groove for being connected to a terminal portion of the personal digital assistant or the battery; and the receiving space is formed with a cover for sealing the object received therein.

6. The foldable input device as claimed in claim 1, wherein any housing is installed with an extending slot for being inserted by extra memory, network card, modem card, or other PCMCIA cards for enhancing the function thereof.

7. The foldable input device as claimed in claim 1, wherein the power is from a built-in battery or from a personal digital assistant; or other external power sources of battery box or AC power source.
